(19) United States
(12) Patent Application Publication
(10) Pub. No.: US 2014/0355849 A1
(43) Pub. Date: Dec. 4, 2014

(54) SYSTEM AND METHOD OF USING IMPRINT ANALYSIS IN PILL IDENTIFICATION

(71) Applicant: MEDSNAP, LLC, Birmingham, AL (US)

(72) Inventors: Stephen E. Brossette, Vestavia Hills, AL (US); Ning Zheng, Hoover, AL (US); Patrick A. Hymel, JR., Mountain Brook, AL (US)

(73) Assignee: MEDSNAP, LLC, Birmingham, AL (US)

(21) Appl. No.: 13/909,821

(22) Filed: Jun. 4, 2013

(51) Int. Cl. G06K 9/62; G06T 7/00

(52) U.S. Cl. CPC G06K 9/6201; G06T 7/0014
USPC 382/128

(57) ABSTRACT

A system and method for identifying a pill by its imprint. A digital pill imprint image for the pill is obtained and compared with one or more composite imprint images in a database. Each of the composite imprint images is a composite of two or more digital pill imprint images of a single type of pill. The composite imprint images are formed by aligning and combining the two or more digital pill imprint images for each type of pill. A match score is determined as a result of the comparing of the digital pill imprint image with each of the composite imprint images. The match score represents a degree of overlap between the digital pill imprint image and each composite imprint image. The pill is identified based on the composite imprint image having the best match score.

### FIELD OF THE INVENTION

The disclosed embodiments relate to digital image processing for identification of pills, and specifically to the use and digital analysis of pill imprints to facilitate identification of pills.

### BACKGROUND OF THE INVENTION

Pills of many shapes, sizes and colors are available as both prescription and non-prescription medications. In the United States, the physical identifiers of solid dosage pharmaceuticals are approved by the Federal Drug Administration. Ideally, no two pills are approved to have exactly the same identifiers. Thus, pills are approved to each have a unique combination of shape, size, color, imprint (i.e., characters or numbers printed on the medication), and/or scoring. Nevertheless, despite the fact that every type of FDA-approved pill is indeed intended to be unique, the differences between pills is sometimes subtle. For example, two pills of the same shape but slightly different colors and/or sizes may easily be confused by a patient. Pills normally differentiated by imprint may not appear to be different at all, for example, if the imprints are not readable because the pills are face-down or the patient has poor vision. Such concerns are exacerbated by the actions of patients who may not be fully coherent or alert.

Patients are not the only individuals who have a need to quickly and easily identify pills. Relatives or caretakers of patients may also have such a need. Their need may stem from their responsibility to provide the correct pills to the patient, or simply from a desire to verify that the patient has taken the correct pills. Hospitals may have a need to quickly identify each of a collection of pills that a person brings from home or that may have been ingested by a child admitted for accidental ingestion of medication. Pharmacies have an interest in ensuring that correct pills are dispensed. Insurance companies may even have an interest in monitoring medication adherence, ensuring that correct pills are dispensed to and taken regularly by the insured. In other words, many parties have an interest in verifying the identity of pills, whether the pills are identified individually or as a collection of various pills.

Pills can be identified using various photographic and image processing methods. For example, a digital image of a pill or collection of pills can be taken, and then image processing methods can be used to determine how many pills are in the image, the location and boundaries of the pills in the image, and to assign pixels in the image to a potential pill for identification. This process of segmentation ideally results in every pixel in the image either being assigned to a pill with well-defined and accurate boundaries or being disregarded as not belonging to any pill. Once pixels are assigned, the accumulated pixels for a given pill can be analyzed to determine the characteristics of the pill (e.g., its size, shape, color and imprint).

Practical and accurate segmentation methods and their use in pill identification are described, for example, in U.S. patent application Ser. No. 13/490,510, filed Jun. 7, 2012, the entirety of which is incorporated herein by reference. Color correction methods used during pill identification are described, for example, in U.S. patent application Ser. No. 13/665,720, filed Oct. 31, 2012, the entirety of which is also incorporated herein by reference.

Despite efforts to identify pills based only on size, shape and color, some pills with similar sizes, shapes and/or colors require analysis of yet an additional characteristic, such as pill imprint, in order to accurately differentiate between the similar pills. Thus, while size, shape and/or color may be used to at least narrow the list of potential matches for a pill's identification, analysis of a pill's imprint may be necessary to achieve a sufficient level of confidence that a pill has been identified correctly. Alternatively, analysis of a pill imprint could also be used as the primary tool for identifying a pill.

In a digital image of one or more pills, however, the pills to be identified may be rotated or positioned haphazardly so as to render imprint analysis difficult. Accordingly, there exists a need for methods that can accurately identify a pill using imprint analysis regardless of the rotation of the pill.

### BRIEF DESCRIPTION OF THE DRAWINGS

FIG. 1 illustrates a method of using pill imprint patterns to identify a pill, in accordance with the present disclosure.

FIGS. 2A-C illustrate various digital pill imprint images, as processed in accordance with the present disclosure.

FIG. 3 illustrates a digital pill imprint image having a center determined in accordance with the present disclosure.

FIG. 4 illustrates a digital pill imprint image having a center determined in accordance with the present disclosure.

FIGS. 5A-E illustrate the overlapping of a digital pill imprint image in FIG. 5B with a digital pill imprint image in FIG. 5A, in accordance with the present disclosure.

FIGS. 6A-E illustrate the overlapping of a digital pill imprint image in FIG. 6B with a digital pill imprint image in FIG. 6A, in accordance with the present disclosure.

FIGS. 7A and 7B illustrate composite imprint images, in accordance with the present disclosure.

FIGS. 8A and 8B illustrate composite imprint images, in accordance with the present disclosure.

FIG. 9 illustrates a method of creating a composite imprint image, in accordance with the present disclosure.

FIG. 10 illustrates a mobile device system for identifying pills using pill imprints, in accordance with the present disclosure.

### DETAILED DESCRIPTION OF THE INVENTION

In the following detailed description, reference is made to the accompanying drawings, which form a part hereof, and in which is shown by way of illustration specific embodiments that may be practiced. It should be understood that like reference numbers represent like elements throughout the drawings. Embodiments are described with sufficient detail to enable those skilled in the art to practice them. It is to be understood that other embodiments may be employed, and that various structural, logical, and electrical changes may be made without departing from the spirit or scope of the invention.

A pill is a tablet, capsule, caplet or other solid unit of medication, prescription or over-the-counter, that is taken orally. Pills vary in appearance by size, shape and imprint, among other features. Pill identification through digital imaging and signal processing takes advantage of these differences in pill appearances to identify a pill. For example, an individual can use a mobile device such as a smartphone to image one or more pills. Software, resident either on the smartphone and/or remote from the smartphone, processes the image to segment the pills, identify features of each imaged pill and then compare the identified features of each pill with a database of pill features in order to determine the identity of each pill. The pill database includes an indication of pill imprint for each pill in the database. Pill imprints are unique for each type of pill. Thus, when one or more pills are imaged, the imprint on each pill may be compared with the imprint patterns stored in the database. A match in imprint pattern is one step in identifying each pill.

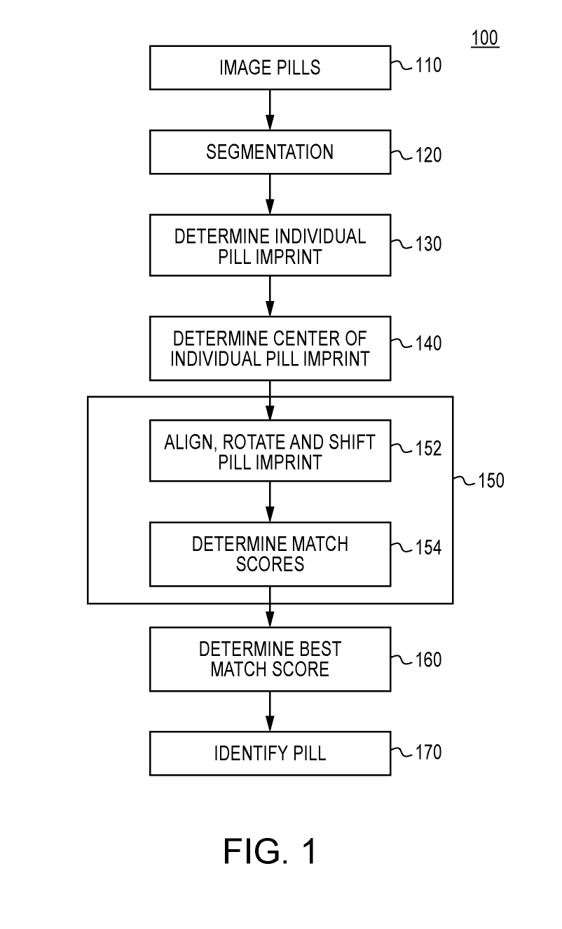

A method of identifying a pill using the pill's imprint pattern is summarized in FIG. 1. In method 100, one or more pills are imaged on a controlled surface (step 110). The resulting image is segmented so that pixels in the image are assigned to individual pills whose identity must be determined (step 120). The pixels associated with each pill are analyzed to determine an individual imprint for each pill (step 130). A center is determined for each imprint image (step 140). The determined individual imprint is then compared with a database of composite imprints, each composite imprint representing a combination of two or more imprints from a same type of pill (step 150). During each comparison, the center of the individual imprint is aligned with the center of the composite imprint and the individual imprint is rotated about its center with respect to the composite imprint to determine the best possible rotational match (step 152). In addition to rotating the individual imprint with respect to the composite imprint, the individual imprint is also shifted in one or more directions to ensure the identification of a best possible rotational match. The value of each best possible rotational match with each compared composite imprint is quantified as a match score (step 154). Based on the individual pill imprint match scores with each composite imprint, the best possible match with a composite imprint is determined (step 160). If the value of the best possible match is acceptable (e.g., beneath a predetermined confidence threshold), the identity of the pill is determined to correspond to the pill associated with the composite imprint providing the best possible match (step 170). Alternatively, the identity of the pill can be determined by considering both the best possible match as determined from the imprint analysis as well as other possible matches in color, size and shape.

Before method 100 can be applied, a database of composite imprints must be created. A composite imprint is essentially a two-dimensional probability histogram that a pixel from a pill image is part of an imprint. Thus, a composite imprint quantifies the likelihood that pixels in an image are part of an imprint for a given pill. In order to create a composite imprint, individual imprints of two or more pills of the same type are obtained and combined. Two or more individual imprints are combined so that noise existent in an imaged individual imprint and not in a second individual imprint can be canceled out, as explained below. Pill imprints are often difficult to see in normal light, and while imprint edges in digital images can be detected using standard edge-finding techniques (as used, e.g., in computer vision technologies), the detected edges may not always be complete or may include significant noise. By combining multiple individual imprints into a composite imprint, the imprint edges can be completed and noise can be reduced.

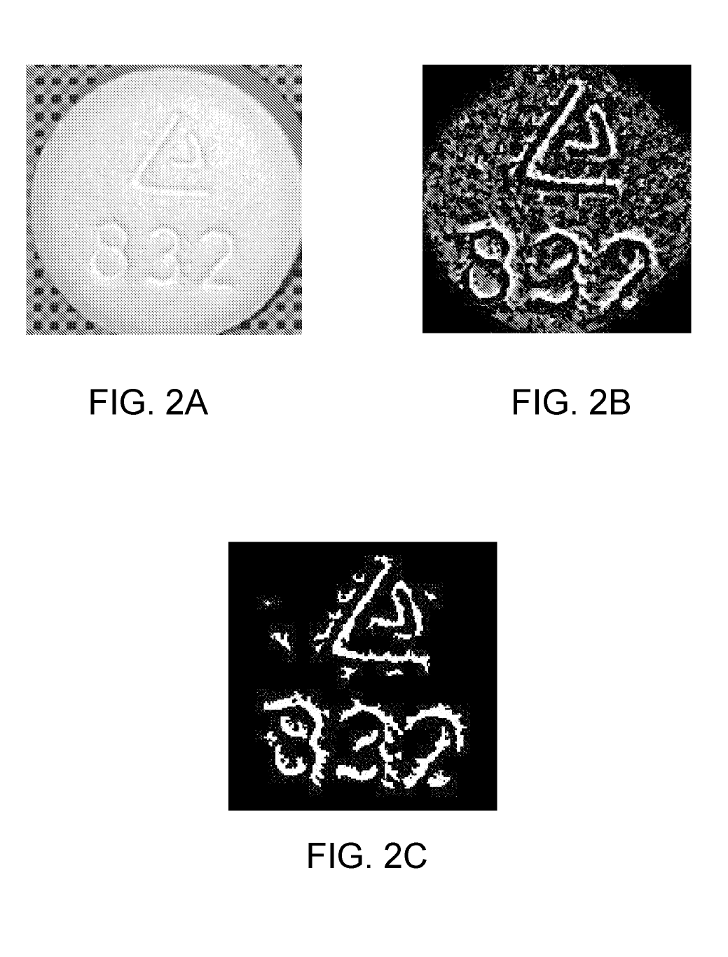

As an example, FIG. 2A illustrates a pill that includes an imprint. In the illustrated example, the pill is white and circular. The viewable face includes an imprint with a number (832) and a triangle-like symbol. As is illustrated in FIG. 2A, the imprint need not be distinguishable by color from the rest of the pill. Often, the imprint on a pill has no distinguishable color and is simply a pattern of indentations on the face of the pill. As such, the imprint can be very difficult to see.

By iteratively using standard adaptive threshold edge-finding techniques, the edges of the imprint on the pill can be detected. For example, FIG. 2B illustrates a fractional individual imprint of the pill in FIG. 2A. The fractional individual imprint is the result of iteratively applying standard adaptive threshold techniques and then normalizing the individual images. As can be seen in the image, the edge detection did detect the imprint but also detected other anomalies or noise. Some of the noise can be removed by setting threshold values for pixels and resetting to zero pixels that have either too much mass (are too bright) or too little mass (are too dim), and then setting any remaining pixels having non-zero mass to some maximum value. The resulting image, a binary individual imprint, is illustrated in FIG. 2C.

Although the pill's imprint is clearly visible in both the fractional individual imprint illustrated in FIG. 2B and the binary individual imprint illustrated in FIG. 2C, both the fractional individual imprint and the binary individual imprint typically still include noise (as is also illustrated in FIGS. 2B and 2C). This noise is reduced by combining either the fractional individual imprint of FIG. 2B or the binary individual imprint of FIG. 2C with another fractional individual imprint or binary individual imprint, respectively, derived from another pill of the same type. The second imprint, either a fractional individual imprint or a binary individual imprint, is prepared via the same process as the first imprint, though there is not a need to ensure that the pills are similarly oriented when imaged; any variations in orientation are accounted for in the combining process, as described below.

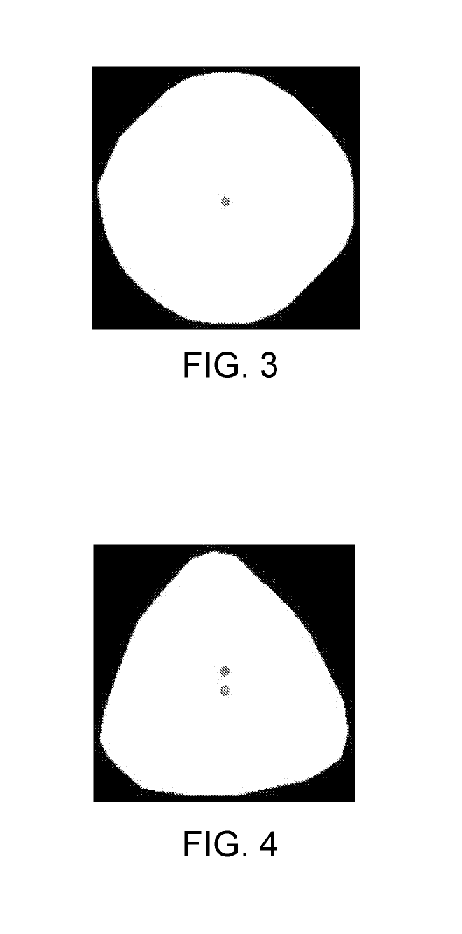

Multiple imprints (either fractional individual imprints or binary individual imprints) are combined by first rotationally aligning the imprints about a center of the pill. This is done by selecting a first or seed individual imprint. The seed individual imprint may be randomly selected from among the available individual imprints for a given pill or may be purposefully selected based on criteria relating to the individual imprint's quality or other measures of the imprint's fitness as a seed imprint. Then, the center of the seed imprint is determined. The center of the seed imprint can either be at the geometric center of the seed image or at the center of mass of the pill's bounding contour. If the imaged pill is symmetric in multiple dimensions, then the geometric center is used. This is determined by bounding the pill's contour with a minimum-area rectangle and then using the center of the rectangle as the center of the seed imprint. FIG. 3 illustrates a circular pill whose center is determined as the geometrical center 310 of a rectangle bounding the pill. If the imaged pill is symmetric in only one-dimension (e.g., a triangular pill or a teardrop-shaped pill), then the center of mass is used as the seed imprint center. FIG. 4 illustrates a triangular-shaped pill whose center is determined as the center of mass 420 of the pill, based on the pill's contour. In the example of FIG. 3, the center of mass is at a different location than the geometrical center 410 because the pill is symmetric in only one dimension.

Once the seed imprint is selected and its rotational center is chosen, a second individual imprint of the same type (either a fractional individual imprint or a binary individual imprint) is selected and its center is also computed. The two imprints are then overlapped such that their computed centers match. The second image is then rotated with respect to the seed image. The rotated angle that results in the best overlap of the two images is determined. Additionally, for each rotation, the second image may be shifted in one or more directions in order to improve the overlap of the two imprint patterns.

As an example, the second image can be rotated with respect to the seed image in increments of a predetermined number of degrees (e.g., two degrees for each rotation). After each rotation, the degree of overlap of the two images is determined. Additionally, after each rotation, the second image can be shifted by one or more pixels in one or more allowed directions, with each shift being tested for its degree of overlap. Then, the second image is re-centered about the seed image and the second image is rotated an additional number of degrees in order to test the degree of overlap at that rotation. At each rotation, the second image is shifted. Thus, for each rotation, the degree of overlap is tested for the un-shifted images as well as for one or more shifted images. The best overlap represents the rotation and shift that best matches the imprints in the images.

Because the two imprint patterns are from the same type of pill, the expectation is that, with appropriate rotation and shifting, the two imprint patterns should have a high degree of overlap. The degree of overlap of the two imprint patterns can be quantified in a variety of ways. For example, a sum of squared pixel-wise differences technique can be used, where the difference in values of overlapping pixels is used to determine the rotation and shift that yields the best possible match. When using a sum of squared pixel-wise differences technique, each comparison (corresponding to a specific rotation and shift) will result in a number. The comparison that results in the lowest number indicates that the second imprint has been rotated and shifted to align with the seed imprint.

Other techniques can be used to find the best possible match between imprints. Instead of using a sum of squared pixel-wise differences technique, other techniques that could be used include a sum of pixel-wise log likelihoods technique, a correlation technique, and a correlation coefficient technique, as are known in the art.

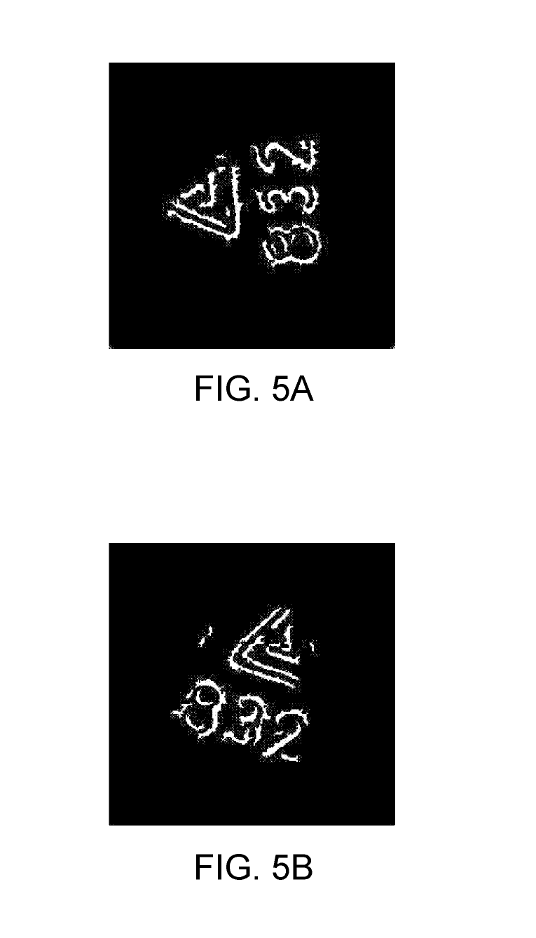

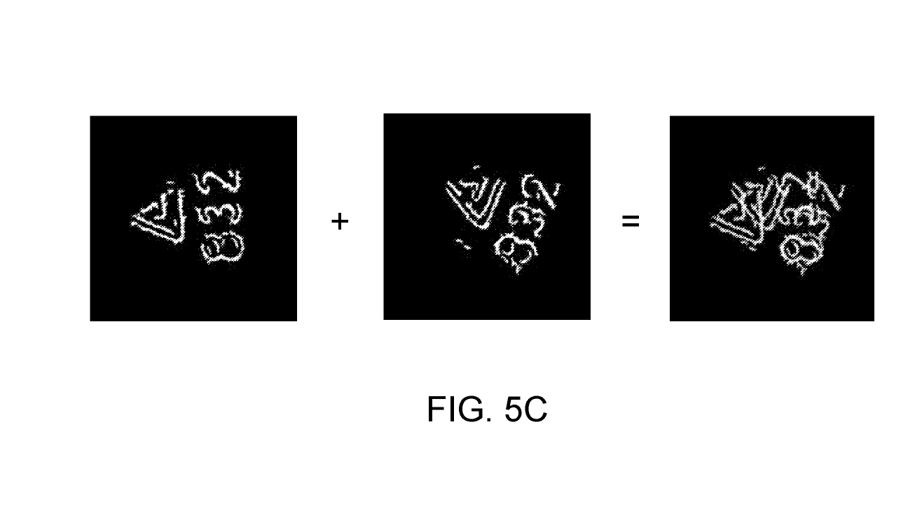

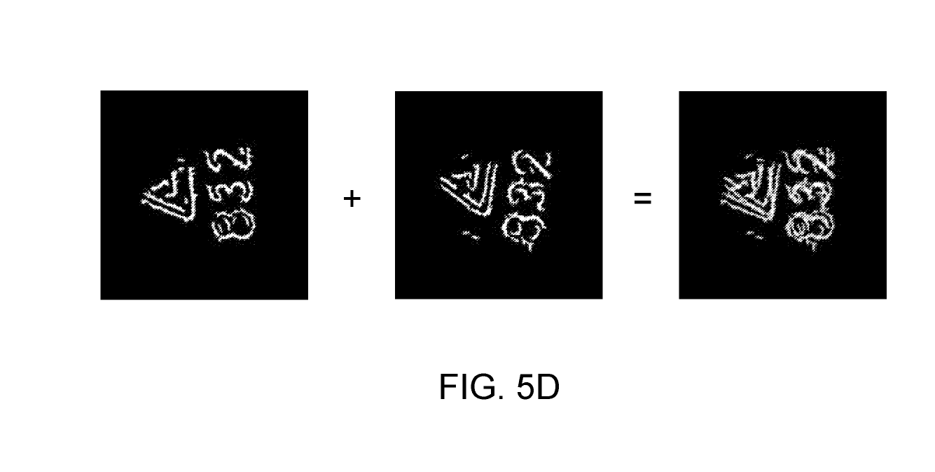

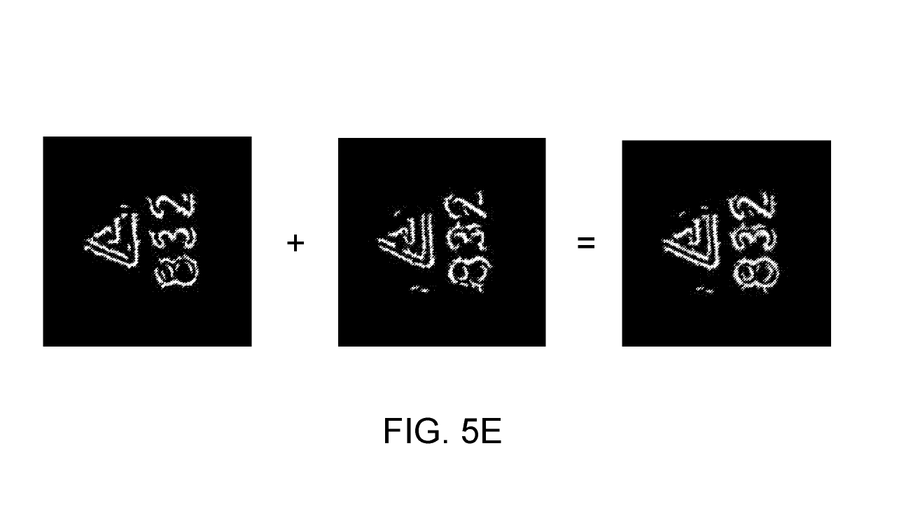

As an example, FIGS. 5A and 5B illustrate two binary individual imprints each taken from a same type of pill (the pill illustrated in FIG. 2A). The binary imprint illustrated in FIG. 5A is a seed imprint and the imprint illustrated in FIG. 5B is to be rotated and shifted to match the seed imprint so as to create a composite imprint. FIGS. 5C, 5D and 5E illustrate various rotations and shifts of the second imprint relative to the seed imprint and the resulting overlap between the seed imprint and rotated and shifted second imprint. Using the sum of squared pixel-wise differences technique to determine a match score for each rotation and shift, the match score of the overlapped imprints in FIG. 5C is 2.6×10⁸. Using the same technique, the match score of the overlapped imprints in FIG. 5D is 2.5×10⁸, while the match score of the overlapped imprints in FIG. 5E is 1.5×10⁸. The lowest score indicates the best possible match, as is illustrated in FIG. 5E.

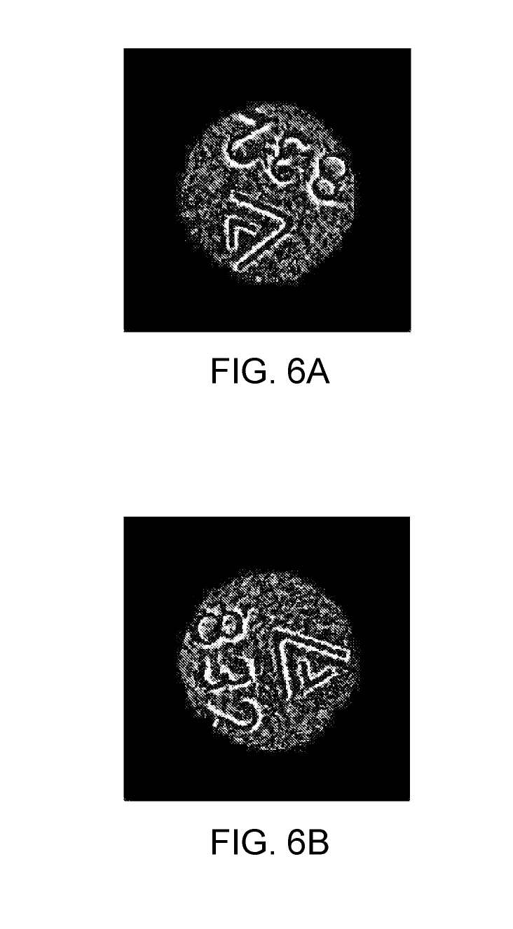

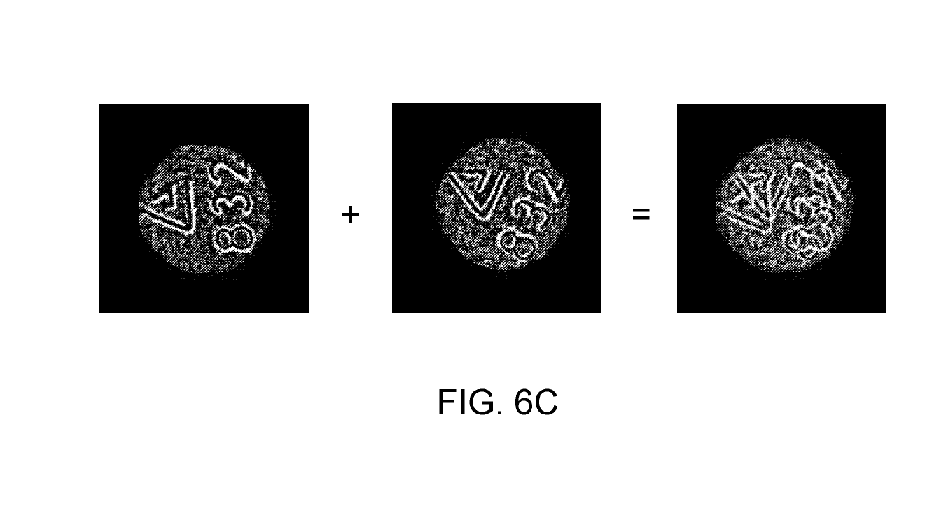

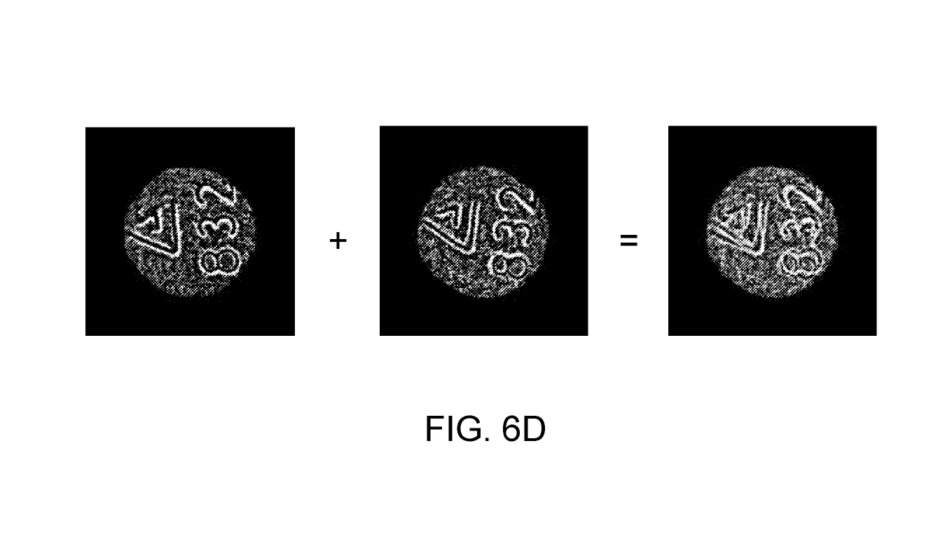

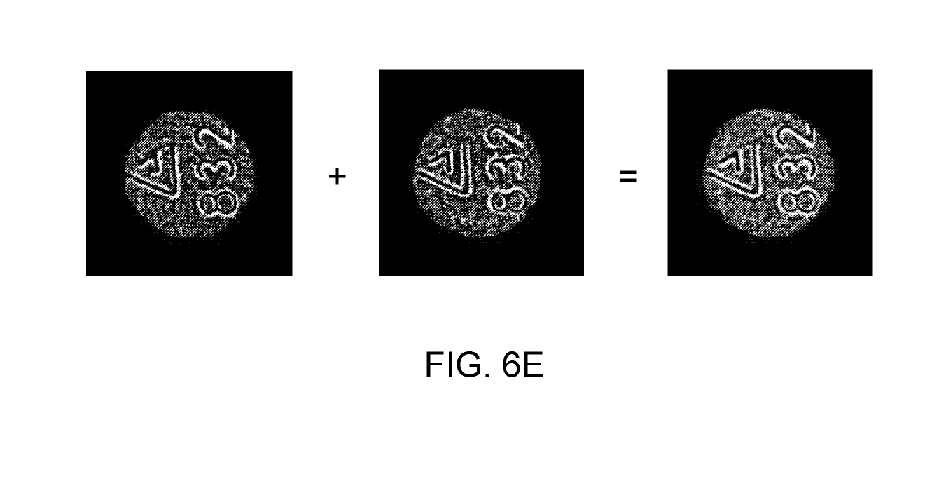

As explained above, fractional individual imprints may be used instead of binary individual imprints. FIGS. 6A and 6B illustrate two fractional individual imprints each taken from a same type of pill (the pill illustrated in FIG. 2A). The fractional imprint illustrated in FIG. 6A is a seed imprint and the imprint illustrated in FIG. 6B is to be rotated and shifted to match the seed imprint so as to create a composite imprint. FIGS. 6C, 6D and 6E illustrate various rotations and shifts of the second imprint relative to the seed imprint and the resulting overlap between the seed imprint and the rotated and shifted second imprint. Using the sum of squared pixel-wise differences technique to determine a match score for each rotation and shift, the match score of the overlapped imprints in FIG. 6C is 2.5×10⁸. Using the same technique, the match score of the overlapped imprints in FIG. 6D is 2.4×10⁸, while the match score of the overlapped imprints in FIG. 6E is 1.6×10⁸. The lowest score indicates the best possible match, as is illustrated in FIG. 6E.

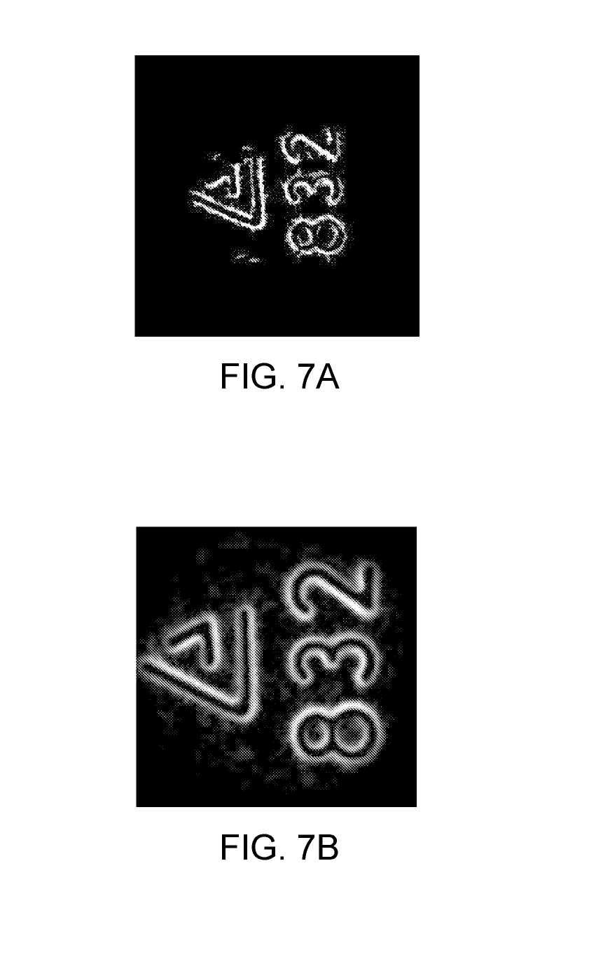

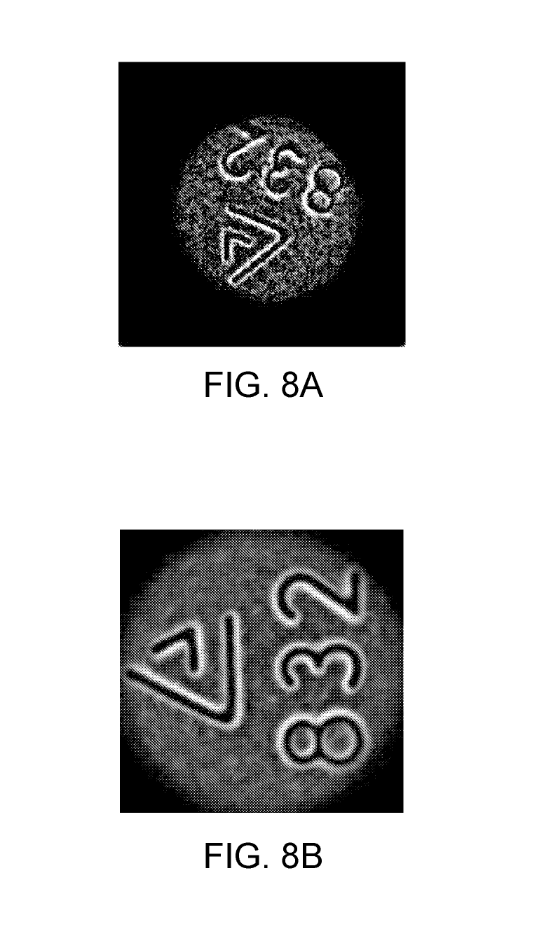

Once at least two individual imprints of a same pill type have been matched, the imprints can be added together to create a combined imprint image. The combined imprint image is then normalized to create a composite imprint. The resulting image can be considered a two-dimensional probability histogram of the imprint. A composite imprint formed by the two binary imprints illustrated in FIGS. 5A and 5B is illustrated in FIG. 7A. Because the two images have been added together and normalized, the resulting composite imprint has less noise and better-defined edges. Using additional binary imprints (i.e., more than two) to form the composite imprint results in even less noise and a more complete imprint in the composite imprint. FIG. 7B illustrates a composite imprint formed from fifty binary individual imprints. A minimum number of binary individual imprints is usually necessary in order to create a composite imprint that is complete and which has sufficiently low noise. Similarly, a composite imprint formed by the two fractional imprints illustrated in FIGS. 6A and 6B is illustrated in FIG. 8A. A composite imprint formed from fifty fractional individual imprints is illustrated in FIG. 8B. As with binary individual imprints, a minimum number of fractional individual imprints is generally necessary in order to create a complete and low-noise composite imprint.

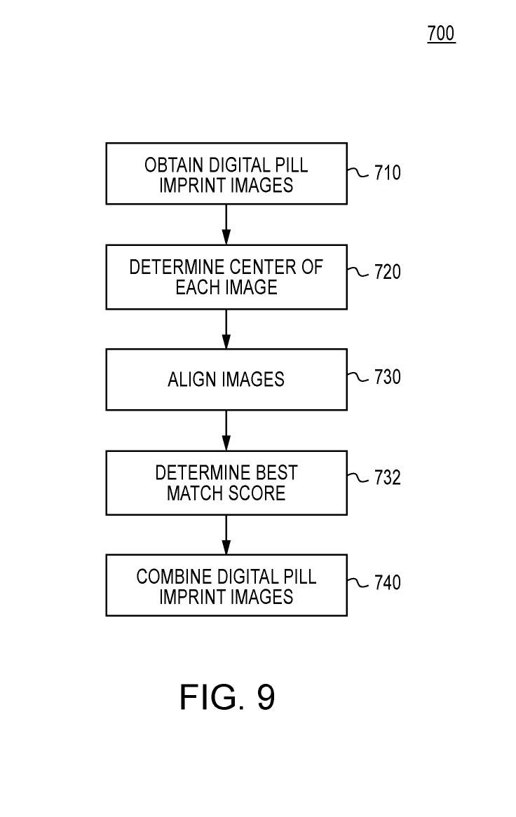

FIG. 9 illustrates a summary of the method 700 used to construct a composite imprint. First, two or more digital pill imprint images of a same type of pill are obtained (step 710). For each digital pill imprint image, a center is determined (step 720) and then digital pill imprint images are aligned by rotating and shifting about their centers (step 730). Alignment includes rotating one of the digital pill imprint images with respect to another (the seed digital pill imprint image) to obtain maximum overlap of the images. Maximum overlap is quantified by a match score (step 732). Once a best match score is determined, the digital pill imprint images are combined by adding them together and normalizing the result (step 740). The normalized result is a composite imprint.

Composite imprints are added to a database of composite imprints and are used to help identify unknown pills. Pills requiring identification are imaged in the same way as described above. Returning again to FIG. 1, a fractional individual or binary individual imprint of the unknown pill is determined (step 130) and then the fractional individual or binary individual imprint is compared with various composite imprints in the composite imprint database to find the best possible match (step 150). Comparison requires rotating and shifting the fractional individual or binary individual imprint with respect to the various composite imprints (step 152) and finding the best match score for each compared composite imprint (step 154). The best match scores for each composite imprint are then compared, and the best of these scores is determined (step 160). This best possible match score indicates that there is a high probability that the unknown pill can be identified as the type of pill to which the matching composite imprint corresponds. If the match score is sufficiently good (e.g., below a predetermined threshold), the unknown pill may be positively identified (step 170).

In order to reduce the number of composite imprints to which the unknown pill must be compared, other characteristics of the unknown pill may also be determined and used to narrow the pool of possible pill types. For example, an unknown pill that is determined to be white and circular-shaped need only have its imprint compared with composite imprints corresponding to pills that are also white and circular-shaped.

The imprint matching and pill identification method described above includes many benefits. A primary benefit of the imprint matching process is that the process does not rely on character recognition. Instead of attempting to recognize characters, the described process identifies patterns and then finds matching patterns, regardless of the shape or type of symbol used in the imprint. Additionally, the process does not require that all pills be oriented in the same direction prior to imaging. Because multiple pills are used to build the composite imprints, the process is noise tolerant and doesn't require “perfect” or unblemished pills.

A further benefit of the disclosed process is that the fractional individual or binary individual imprints obtained from pills can also convey surface texture information for the associated pill (e.g., whether the pill's surface is smooth or rough). This type of information can also be used to help identify an unknown pill.

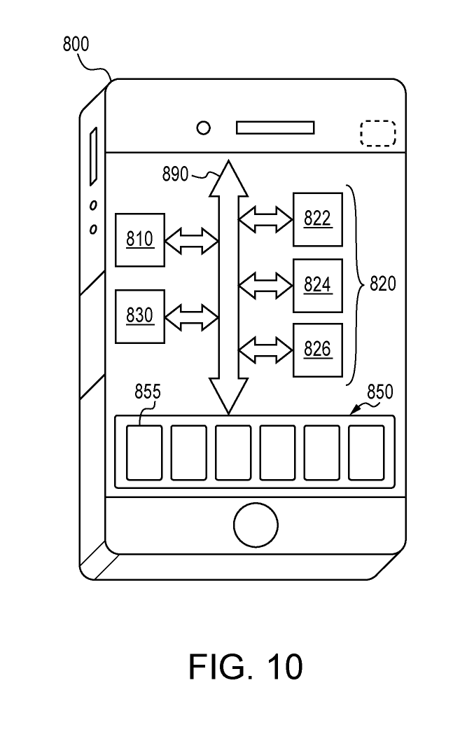

Methods 100 and 700 can be implemented as either hardware or software, or a combination thereof. A mobile device 800, as illustrated in FIG. 10, includes a system 850 for implementing methods 100 and 700. The system 850 includes an imprint matching module to be used in conjunction with the mobile devices' camera, processor and a database. The mobile device 800 generally comprises a central processing unit (CPU) 810, such as a microprocessor, a digital signal processor, or other programmable digital logic devices, which communicates with various input/output (I/O) devices 820 over a bus or other interconnect 890. The input/output devices 820 include a digital camera 822 for inputting digital images of pills on the controlled surface. The input/output devices may also include a user interface 824 to display pill identification results to a user, and a transmitter 826 for transmission of the pill identification results to a remote location. A memory device 830 communicates with the CPU 810 over bus or other interconnect 890 typically through a memory controller. The memory device 830 may include RAM, a hard drive, a FLASH drive or removable memory for example. The memory device 830 includes one or more databases. The CPU 810 implements the methods 100, 700 as applied to the digital image obtained by camera 822. In method 100, the CPU 810 processes the digital image, determines one or more fractional individual or binary individual imprints from pills included in the digital image, and compares the determined imprints with one or more composite imprints stored in one or more databases. At least one of the composite imprint databases may be stored in the memory device 830. The CPU 810 outputs pill identification results based on the comparison of the fractional individual or binary individual imprints with the composite imprints. Pill identification results are output via the user interface 824 and/or the transmitter 826. If desired, the memory device 830 may be combined with the processor, for example CPU 810, as a single integrated circuit.

System 850 includes an imprint matching module 855. The imprint matching module 855 performs methods 100 and 700. System 850 may also include other modules used to identify the color, size and shape of the imaged pills. As an example, system 850 and the modules used within system 850 may be implemented as an application on a smartphone.

The above description and drawings are only to be considered illustrative of specific embodiments, which achieve the features and advantages described herein. Modifications and substitutions to specific process conditions can be made. Accordingly, the embodiments of the invention are not considered as being limited by the foregoing description and drawings, but is only limited by the scope of the appended claims.

What is claimed as new and desired to be protected by Letters Patent of the United States is:

1. A method of creating a database of pill imprint images, the method comprising:
obtaining two or more digital pill imprint images for each type of a plurality of types of pills;
aligning the two or more digital pill imprint images for each type of pill;
combining the two or more digital pill imprint images for each type of pill into a single composite imprint image for each type of pill; and
storing the composite imprint image in a database such that the composite imprint image is associated with the corresponding type of pill.

2. The method of claim 1, wherein obtaining two or more digital pill imprint images for each type of pill includes obtaining digital pill imprint images from different pills of the same type for each of the plurality of types of pills.

3. The method of claim 1, wherein digital pill imprint images for each type of pill are obtained by normalizing the results of using edge-finding and adaptive threshold techniques.

4. The method of claim 1, further comprising converting the digital pill imprint images for each type of pill into binary pill imprint images.

5. The method of claim 1, further comprising determining a center of each of the digital pill imprint images.

6. The method of claim 5, wherein the center of each digital pill imprint image is a geometric center of a smallest-area rectangle bounding a contour of the pill imaged in each digital pill imprint image.

7. The method of claim 5, wherein the center of each digital pill imprint image is a center of mass based on a contour of the pill imaged in each digital pill imprint image.

8. The method of claim 5, wherein aligning the two or more digital pill imprint images for each type of pill further comprises selecting a seed digital pill imprint image from the two or more digital pill imprint images for each type of pill and aligning the centers of the other digital pill imprint images corresponding to the same type of pill with the center of the seed digital pill imprint image.

9. The method of claim 8, further comprising rotating about the aligned pill centers each of the other digital pill imprint images with respect to the seed digital pill image in order to maximize the overlap of the digital pill imprint images.

10. The method of claim 9, further comprising, for each rotation, shifting each of the other digital pill imprint images with respect to the seed digital pill image in order to maximize the overlap of the digital pill imprint images.

11. The method of claim 10, wherein the degree of overlap of each of the other digital pill imprint images with the seed pill imprint image is determined as a match score using at least one of the following: a sum of squared pixel-wise differences, a sum of pixel-wise log likelihoods, correlation, and a correlation coefficient.

12. The method of claim 11, further comprising determining a rotation and shift resulting in a best match score for each of the other digital pill imprint images with respect to the seed digital pill imprint image.

13. The method of claim 12, wherein combining the two or more digital pill imprint images includes adding the pixel values of the seed digital pill imprint image and each of the other digital pill imprint images after each of the other digital pill imprint images are rotated and shifted to obtain the best match score.

14. The method of claim 13, further comprising normalizing the added images to the single composite imprint image for each type of pill.

15. A method of identifying a pill by its imprint, the method comprising:
obtaining a digital pill imprint image for the pill;
comparing the digital pill imprint image with one or more composite imprint images in a database, each of the composite imprint images being a composite of two or more digital pill imprint images of a single type of pill, said comparing including determining a match score for each compared composite imprint image, said match score representing a degree of overlap between the digital pill imprint image and each composite imprint image; and
identifying the pill based on the composite imprint image having the best match score.

16. The method of claim 15, wherein said comparing includes determining a center of the digital pill imprint image.

17. The method of claim 16, wherein the center of the digital pill imprint image is a geometric center of a smallest-area rectangle bounding a contour of the pill imaged in the digital pill imprint image.

18. The method of claim 16, wherein the center of the digital pill imprint image is a center of mass based on a contour of the pill imaged in the digital pill imprint image.

19. The method of claim 16, wherein comparing further comprises aligning the center of the digital pill image with centers of the one or more composite imprint images.

20. The method of claim 19, further comprising, for each composite imprint image with which the digital pill imprint image is aligned, rotating the digital pill imprint image about the aligned pill centers in order to maximize the overlap of the digital pill imprint image with each of the composite imprint images.

21. The method of claim 20, further comprising, for each rotation of the digital pill imprint image, shifting the digital pill imprint image with respect to each composite imprint image in order to maximize the overlap of the digital pill imprint image with each of the composite imprint images.

22. The method of claim 21, wherein the degree of overlap of the digital pill imprint image with each of the composite imprint images is determined as a match score using at least one of the following: a sum of squared pixel-wise differences, a sum of pixel-wise log likelihoods, correlation, and a correlation coefficient.

23. The method of claim 22, further comprising determining a best match score for each composite imprint image with respect to the digital pill imprint image.

24. A storage device comprising:
at least a portion of a database which associates a plurality of different types of pills with a corresponding plurality of composite imprint images, each of the plurality of composite imprint images in the storage device being comprised of:
a combination of two or more digital pill imprint images added together.

25. The storage device of claim 24, wherein the two or more digital pill imprint images of each composite imprint image are aligned about their centers to form the corresponding composite imprint image.

26. The storage device of claim 25, wherein the center of each digital pill imprint image is a geometric center of a smallest-area rectangle bounding a contour of the pill imaged in each digital pill imprint image.

27. The storage device of claim 25, wherein the center of each digital pill imprint image is a center of mass based on a contour of the pill imaged in each digital pill imprint image.

28. The storage device of claim 25, wherein one of the two or more digital pill imprint images of each composite imprint image is a seed pill imprint image and the other digital pill imprint images are aligned with the seed pill imprint image by rotating and shifting the other digital pill imprint images about the aligned pill centers in order to maximize the overlap of the digital pill imprint images.

29. The storage device of claim 28, wherein the degree of overlap of each of the other digital pill imprint images with the seed pill imprint image is quantified as a match score using at least one of the following: a sum of squared pixel-wise differences, a sum of pixel-wise log likelihoods, correlation, and a correlation coefficient.

30. The storage device of claim 29, wherein the two or more digital pill imprint images are combined when each of the other digital pill imprint images are aligned in correspondence with a best match score with respect to the seed pill imprint image.

31. The storage device of claim 24, wherein the storage device is a component in a mobile device.

32. The storage device of claim 24, wherein the database is configured to be accessed by a mobile device.

33. A system configured to identify a pill by its imprint, the system comprising:
a digital camera; and
a processor for receiving from the digital camera a digital image including at least one pill to be identified and for determining a digital pill imprint image for at least one of the at least one pill to be identified, the processor configured to use an imprint matching module to compare the digital pill imprint image with one or more composite imprint images in a database, each of the composite imprint images being a composite of two or more digital pill imprint images of a single type of pill.

34. The system of claim 33, wherein said imprint matching module is configured to determine a match score for each compared composite imprint image, said match score representing a degree of overlap between the digital pill imprint image and each composite imprint image.

35. The system of claim 34, wherein said imprint matching module is configured to determine a center of the digital pill imprint image.

36. The system of claim 35, wherein the center of the digital pill imprint image is a geometric center of a smallest-area rectangle bounding a contour of the pill imaged in the digital pill imprint image.

37. The system of claim 35, wherein the center of the digital pill imprint image is a center of mass based on a contour of the pill imaged in the digital pill imprint image.

38. The system of claim 35, wherein said imprint matching module is further configured to align the center of the digital pill image with centers of the one or more composite imprint images.

39. The system of claim 38, wherein said imprint matching module is further configured to, for each composite imprint image with which the digital pill image is aligned, rotate and shift the digital pill image about the aligned pill centers in order to maximize the overlap of the digital pill image with each of the composite imprint images.

40. The system of claim 39, wherein the degree of overlap of the digital pill image with each of the composite imprint images is determined as a match score using at least one of the following: a sum of squared pixel-wise differences, a sum of pixel-wise log likelihoods, correlation, and a correlation coefficient.

41. The system of claim 40, wherein said imprint matching module is further configured to determine a best match score for each composite imprint image with respect to the digital pill image.
